(19) United States
(12) Patent Application Publication
(10) Pub. No.: US 2019/0106342 A1
(43) Pub. Date: Apr. 11, 2019

(54) ALTERNATIVE CARBON SOURCES FOR THE CONTROL OF NITROGEN CONCENTRATION IN WATER

(71) Applicant: Performance Chemicals LLC, Franklin, NH (US)

(72) Inventors: Nicholas P. SALAMONE, Northwood, NH (US); Michael R. CURRIER, Gilford, NH (US); Robert T. CURRIER, Canterbury, NH (US); Timothy H. COLLINS, Rockport, MA (US)

(21) Appl. No.: 16/150,622

(22) Filed: Oct. 3, 2018

Related U.S. Application Data
(60) Provisional application No. 62/569,123, filed on Oct. 6, 2017.

(51) Int. Cl. C02F 3/30

(52) U.S. Cl. CPC C02F 3/305; C02F 2101/105; C02F 3/308

(57) ABSTRACT

The system and method of improved denitrification of wastewater using an external carbon source composition. The composition is a mixture that comprises a diluent and a surfactant. Optionally, the mixture may comprise additional components. The mixture may comprise polysorbate 80 as the surfactant and crude glycerin as the diluent. The additional component may be the result of a lack of purity in the diluent, or it may be added separately. In some cases, the surfactant may be degraded.

### FIELD OF THE DISCLOSURE

The present disclosure relates to wastewater treatment and more particularly to improved denitrification methods using superior carbon sources.

### BACKGROUND OF THE DISCLOSURE

Discharge permits for waste water often include effluent limits for nutrients, including nitrogen. Total maximum daily loads (TMDLs) for nutrients have and are being developed for many water bodies throughout the United States. These limits are used to protect water bodies and changes to these limits to protect impaired water bodies have resulted in more stringent effluent limits for total nitrogen. A TMDL is the calculation of the maximum amount of a pollutant allowed to enter a waterbody so that the waterbody will meet and continue to meet water quality standards for that particular pollutant. A TMDL determines a pollutant reduction target and allocates load reductions necessary to the source(s) of the pollutant.

In order to achieve very low total nitrogen limits (e.g., less than 6 mg/L) through biological denitrification, a readily biodegradable carbon source must be available for the denitrifying organisms to use. A supplemental external carbon source is often used when organic material in the wastewater has already been oxidized. This is especially true in denitrification processes that are located after an aeration step.

Denitrifying bacteria utilize carbon as an energy source to drive metabolism as well as for the synthesis of new cellular material. In some cases, they obtain their carbon needs from organic compounds or from carbon dioxide. Heterotrophic microorganisms, which are commonly used in the denitrification step, are able to utilize organic carbon sources while autotrophic organisms utilize carbon dioxide as a carbon source. When the microorganisms utilize organic carbon as a substrate, energy is produced by the oxidation of organic carbon to carbon dioxide.

Generally, carbon sources are termed external when the carbon substrate is sourced from outside the wastewater treatment process. External carbon sources are brought into the wastewater treatment process usually as pure compounds or high strength waste materials where concentrations can be as high as 1.5 g/L chemical oxygen demand (COD) to facilitate nutrient removal. Conversely, internal carbon sources refer to organic carbon substrates obtained either within the influent wastewater (as an organic wastewater load entering into the plant from the influent) or from accumulated materials stored within the bacterial cells.

Nitrogen removal from wastewater involves the initial transformation of ammonia and organic nitrogen to nitrates via nitrification. Then, the subsequent elimination of nitrogen through denitrification can take place. Because nitrification typically only occurs following carbonaceous biological oxygen demand (BOD) removal, the limiting factor for effective denitrification is often the absence of a readily biodegradable carbon source that can be used as an effective substrate by the denitrifying bacteria during the denitrification process. Without a source of biodegradable carbon, denitrification will not occur, or will occur so slowly that sufficient nitrogen removal will not occur.

When selecting an external carbon source, there are many factors to consider in addition to cost. One consideration is safety. Several known external carbon sources (e.g., methanol, ethanol) are flammable and are not only dangerous to transport, but are also risky to store onsite. Another consideration is availability/price fluctuation. Some known external carbon sources derived from fossil fuel based sources can have wide fluctuations in supply and price. Yet another consideration is purity. Some external carbon sources are derived from waste products and as such may have ranges of purity. In some cases, the impurities may have negative effects on the denitrifying bacteria. Additionally, the rate of denitrification, viscosity and handling issues, product stability, and the freezing points for the external carbon sources must also be considered depending on the application.

According to the EPA, the dosage requirement for an external carbon source used in denitrification is typically the amount of COD that is required to remove each unit of nitrate (i.e., the COD:N ratio, which is usually expressed as lbs COD/lbs NO₃—N removed). This ratio is affected by factors such as the nature of the carbon source, the species of biomass supported, the electron donor capacity of the carbon source, the solids retention time (SRT) of the treatment system and the sludge yields associated with bacterial species supported by the carbon source.

Kinetic considerations typically focus on the specific denitrification rates and the biomass growth rates associated with the carbon source. This is generally a function of the species of biomass that are selected for use in the treatment process when a carbon source is utilized.

Wherefore it is an object of the present disclosure to overcome the above mentioned shortcomings and drawbacks associated with the prior art external carbon sources.

### SUMMARY OF THE DISCLOSURE

One aspect of the present disclosure is an external carbon source composition for use in the biological denitrification of wastewater comprising: a diluent; and a surfactant, wherein the diluent concentration ranges from about 50% to about 99% of the composition and the surfactant concentration range from about 1% to about 50% of the composition.

One embodiment of the external carbon source composition further comprises additional components at a concentration ranging from about 1% to about 30% of the composition. In some cases, the diluent is crude glycerin and the surfactant is polysorbate 80. In certain embodiments, the diluent concentration is about 90% and the surfactant concentration is about 10%.

Another embodiment of the external carbon source composition is wherein the diluent is crude glycerin, the surfactant is polysorbate 80, and the concentration of additional components is a result of the lack of purity in the crude glycerin. In some cases, the surfactant has been degraded.

Another aspect of the present disclosure is a method for biological denitrification of wastewater comprising: providing an external carbon source comprising: a diluent; and a surfactant, wherein the diluent concentration ranges from about 50% to about 99% of the composition and the surfactant concentration range from about 1% to about 50% of the composition.

One embodiment of the method for biological denitrification of wastewater further comprises additional components at a concentration ranging from about 1% to about 30% of the composition.

In some cases, the diluent is crude glycerin and the surfactant is polysorbate 80. In certain embodiments, the diluent concentration is about 90% and the surfactant concentration is about 10%.

Another embodiment of the method for biological denitrification of wastewater is wherein the diluent is crude glycerin, the surfactant is polysorbate 80, and the concentration of additional components is a result of the lack of purity in the crude glycerin. In some cases, the surfactant has been degraded.

Yet another embodiment of the method for biological denitrification of wastewater is wherein the external carbon source is added after phosphate removal is completed.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a table of known external carbon sources compared to two embodiments of the mixtures according to the principles of the present disclosure.

### DETAILED DESCRIPTION OF THE DISCLOSURE

Many industries and municipalities have effluent streams that must be discarded as waste. Per the United States Environmental Protection Agency (EPA), these waste streams typically have maximum allowable levels of particulate matter, dissolved solids, nutrients, and other compounds before they can be discharged to the environment.

Wastewater treatment facilities are utilized to treat this water to acceptable levels of containments prior to discharge. One of these contaminants is nitrogen, usually in the form of ammonia or organic nitrogen compounds. Through biological oxidation, the ammonia and other organic nitrogen compounds are converted to nitrates or nitrites. Once nitrogen compounds and dissolved oxygen levels are sufficiently depleted, conditions are ripe for anaerobic respiration.

Bacterial denitrification uses the process of anaerobic respiration to remove oxidized nitrogen compounds from the waste water in the form on nitrogen gas bubbles. These particular bacteria, however, require an external carbon source to carry out the denitrification process. Typical external carbon sources are low molecular weight compounds such as, methanol, ethanol, glycerol, and acetic acid.

As noted above, when selecting an external carbon source there are many factors to consider in addition to cost. One consideration is safety. Several known external carbon sources (e.g., methanol, ethanol) are flammable and are not only dangerous to transport, but are also risky to store onsite in large quantities. Another consideration is availability/price fluctuation. Some known external carbon sources derived from fossil fuel based sources can have wide fluctuations in both supply and price. On the other hand, some plant based external carbon sources (e.g., molasses and sucrose) are more predictable.

Yet another consideration in selecting an external carbon source is purity. Some external carbon sources are derived from waste products and as such may have ranges of purity. In some cases, the impurities may have negative effects on the denitrifying bacteria. Additionally, the rate of denitrification, viscosity and handling issues, product stability, and the freezing points for the external carbon sources must also be considered depending on the application.

One embodiment of the present disclosure is an external carbon source for use with denitrifying bacteria that can supply sufficient carbon for the denitrification process at lower addition levels than those typically used in the industry. In one embodiment, the external carbon source is comprised of diluent and a surfactant. In certain embodiments, additional components may be present in the external carbon source mixture. Those additional components may be supplied to the mixture separately, or they may be a result of the lack of purity in the surfactant and/or diluent.

In some cases, the external carbon source comprises about 1% diluent and about 99% surfactant (wt/wt). In certain embodiments, the external carbon source comprises about 10% diluent and about 90% surfactant. In certain embodiments, the external carbon source comprises about 20% diluent and about 80% surfactant. In certain embodiments, the external carbon source comprises about 30% diluent and about 70% surfactant. In certain embodiments, the external carbon source comprises about 40% diluent and about 60% surfactant. In certain embodiments, the external carbon source comprises about 50% diluent and about 50% surfactant. In certain embodiments, the external carbon source comprises about 60% diluent and about 40% surfactant. In certain embodiments, the external carbon source comprises about 70% diluent and about 30% surfactant. In certain embodiments, the external carbon source comprises about 80% diluent and about 20% surfactant. In certain embodiments, the external carbon source comprises about 90% diluent and about 10% surfactant. In certain embodiments, the external carbon source comprises about 99% diluent and about 1% surfactant.

In certain embodiments, the external carbon source comprises additional components at less than 40% (wt/wt). In some cases, the additional components are less than 35%, less than 30%, less than 25%, or less than 20%. In some cases, the additional components are less than 15%, less than 10%, less than 5%, or less than 2%. In some cases, the additional components may comprise, acids, bases, salts, surfactants, diluents, triglycerides, fatty acids, fatty acid methyl esters, matter organic non-glycerol (MONG) or the like.

In certain embodiments the amount of diluent in the external carbon source ranges from about 99% to about 1% (wt/wt). In some cases, the amount of diluent in the external carbon source ranges from about 99% to about 10%. In some cases, the amount of diluent in the external carbon source ranges from about 99% to about 20%. In some cases, the amount of diluent in the external carbon source ranges from about 99% to about 30%. In some cases, the amount of diluent in the external carbon source ranges from about 99% to about 40%. In some cases, the amount of diluent in the external carbon source ranges from about 99% to about 50%. In some cases, the amount of diluent in the external carbon source ranges from about 99% to about 60%. In some cases, the amount of diluent in the external carbon source ranges from about 99% to about 70%. In some cases, the amount of diluent in the external carbon source ranges from about 99% to about 80%. In some cases, the amount of diluent in the external carbon source ranges from about 99% to about 90%.

In some cases, the diluent is a carbon containing diluent, (e.g., glycerin, methanol, sucrose, and the like), but if the diluent is water or another non-carbon containing diluent, then the surfactant percentage might be on the higher % side as compared to the diluent % per the external carbon source mixture.

In certain embodiments, the amount of surfactant in the carbon source ranges from about 1% to about 99% (wt/wt). In some cases, the amount of surfactant in the carbon source ranges from about 1% to about 89%. In some cases, the amount of surfactant in the carbon source ranges from about 1% to about 79%. In some cases, the amount of surfactant in the carbon source ranges from about 1% to about 69%. In some cases, the amount of surfactant in the carbon source ranges from about 1% to about 59%. In some cases, the amount of surfactant in the carbon source ranges from about 1% to about 49%. In some cases, the amount of surfactant in the carbon source ranges from about 1% to about 39%. In some cases, the amount of surfactant in the carbon source ranges from about 1% to about 29%. In some cases, the amount of surfactant in the carbon source ranges from about 1% to about 19%. In some cases, the amount of surfactant in the carbon source ranges from about 1% to about 9%.

In some cases, the preferred surfactant percentage would be in the 1% to about 50% range, but it is important to consider the kinetics of the denitrification process aren't negatively affected by a high molecular weight surfactant. I think that from our test results so far, we would prefer a carbon containing diluent, most specifically by-product crude glycerin from the production of biodiesel. In some cases, the surfactant should be a water-soluble, bio-degradable, high molecular weight (e.g., >400 g/mol) molecule.

In one embodiment of the composition of the present disclosure, the external carbon source utilizes crude glycerin from the production of biodiesel, as the diluent. In certain embodiments, the external carbon source further comprises a long chain organic surfactant which provides a greater concentration of available carbon per unit volume.

In one embodiment of the composition of the present disclosure, the external carbon source comprises about 90% crude glycerin as diluent and about 10% polysorbate 80 as surfactant. Polysorbate 80 is a water soluble long-chain organic surfactant with 64 carbons with a MW=604.8 g/mol.

In one embodiment, diluents include, but are not limited to alcohols up to C₆, branched/unbranched (e.g., methanol, ethanol, propanol, butanol, etc.), esters, glycerin, crude glycerin, bio-diesel production waste (e.g., crude glycerin, fatty acids, triglycerides, fatty acid methyl esters, and matter organic non-glycerol (MONG)), sucrose, fructose, sugar water, molasses, distillation residue (e.g., residues from spirit (e.g., vodka, whiskey, rum) distillation, corn syrup, water, acetic acid, sodium acetate, and other acetates (e.g., potassium acetate, simple salts of acetic acid), and the like.

Surfactants are usually organic compounds that are amphiphilic, meaning they contain both hydrophobic groups and hydrophilic groups. Therefore, a surfactant contains both a water-insoluble component and a water-soluble component. Surfactants will diffuse in water and adsorb at interfaces between air and water or at the interface between oil and water, in the case where water is mixed with oil. The water-insoluble hydrophobic tail group may extend out of the bulk water phase, into the air or into the oil phase, while the water-soluble head group generally remains in the water phase. In some cases, the hydrocarbon tail portion is branched, linear, or even aromatic.

In one embodiment, surfactants include, but are not limited to, long-chain organic surfactants (e.g., sorbitans, polysorbates, ethoxylated fatty alcohols, etc.), short-chain organic surfactants, or a blend of long and short chain surfactants. In some cases, long-chain, as used herein, means a carbon chain with greater than six carbons branched/unbranched and short-chain means a carbon chain with fewer than six carbons branched/unbranched. In certain embodiments, the surfactants may be modified, degraded or otherwise. In certain embodiments, the surfactants may be attacked with acids like acetic acid or citric acid and/or with heat and/or light to break down the carbon chain to make it more easily consumed by the bacteria. In certain cases, the acid may include a carbon containing acid. In some cases, the surfactant may be “out-of-spec” because of age or exposure to light, or its container was opened, or the like. In certain embodiments, the surfactants are exposed to a carbon containing acid or base to bring the pH to a preferred value, e.g., pH 2-14.

In some cases, the surfactants can be nonionic, anionic, cationic, or zwitterionic. Anionic surfactants contain anionic functional groups at their head portion, including sulfate, sulfonate, phosphate, carboxylate, and the like. Cationic head groups contain cationic functional head groups. The cationic functional groups may be pH dependent such as primary or secondary amines. A zwitterionic surfactant has both an anionic and cationic center on the same molecule. A nonionic surfactant has oxygen-containing hydrophilic groups covalently bonded to hydrophobic groups. Because the water-solubility of the oxygen groups is the result of hydrogen bonding, and hydrogen bonding decreases with increasing temperature, the water solubility of nonionic surfactants decreases with increasing temperature.

Some nonionic surfactants include ethoxylates, sulfoxides, amine oxides, phosphine oxides, and fatty acid esters of polyhydroxy compounds. Some exemplary fatty acid esters of this group include fatty acid esters of glycerol, sorbitol, sucrose, and other alkyl polyglucosides. Some fatty acid esters of sorbitol include, for example, sorbitan mono laurate, sorbitan monostearate, and polysorbate. Polysorbate 80 is derived from polyethoxylated sorbitan and oleic acid. The numeric designation following polysorbate refers to the lipophilic group (in this case oleic acid). Polysorbate 80 has a chemical formula of C₆₄H₁₂₄O₂₆ and is also referred to as polyoxyethylene (20) sorbitan monooleate. It is a soluble, stable, non-flammable, and viscous liquid (300-500 centistokes @25° C..).

In certain embodiments, the surfactant is rich in carbon and has a high molecular weight such that a lower amount can provide the carbon necessary for denitrification. In some cases, water soluble, bio-degradable surfactants can more easily breakdown to become a readily available carbon source. In certain cases, a combination of crude glycerin and Polysorbate 80 is a preferred combination because the bacteria utilize the glycerin while the Polysorbate 80 breaks down, thus the surfactant does not negatively affect the kinetics. In some cases, the mixture, such as Polysorbate 80 /glycerin can supply more useable carbon to the bacteria at a lower dosage rate as compared to 100% crude glycerin.

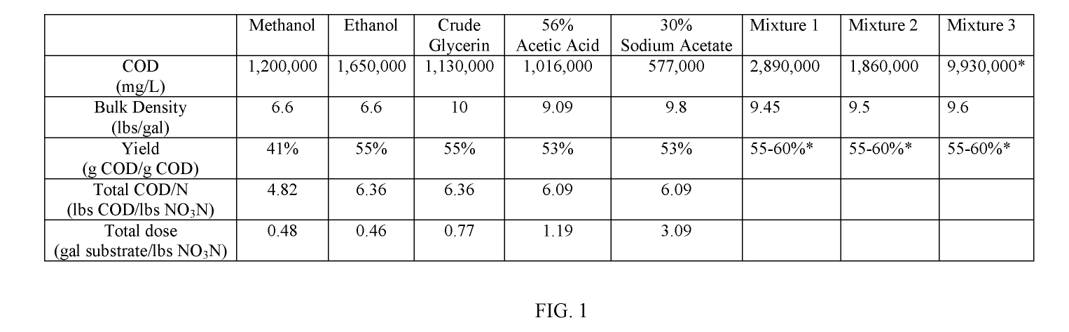

Referring to FIG. 1, a table of known external carbon sources compared to two embodiments of the mixtures according to the principles of the present disclosure is shown. More particularly, methanol, ethanol, crude glycerin, 56% acetic acid and 30% sodium acetate are shown and represent traditional external carbon sources. Also, two mixtures according to the principles of the present disclosure are shown. Mixture 1 comprises 10% polysorbate 80 and 90% crude glycerin. Mixture 2 comprises 10% polysorbate 80, which has been degraded by heat and acetic acid mixed with 90% crude glycerin. Mixture 3 comprises 50% polysorbate 80 and 50% crude glycerin. In some cases, crude glycerin can have comprise at least 70% pure glycerin, at most 1% methanol, at most 1% fatty acid content, and at most 100 mg/L sulfated ash content. In some cases, the pH of the crude glycerin ranges from about 4 to about 11 and the COD concentration is at least 1,000,000 mg/L.

Based on calculations using data from Mixture 1, the values for Mixture 3 are theoretical. One assumption made is that Mixture 3 will still yield an average of about 55-60% during usage and thus would reduce the usage of substrate required by 8×-9×. Mixture 1 and 2 if they yield in the 55-60% range would still reduce usage by 2×-3×. We haven't had the 50% Polysorbate 80-50% PC Glycerin tested for COD levels yet. But based on our CS-04 data, we can theorize with 5 times more polysorbate 80, the COD should be 9,930,000 mg/L. This is the bold statement we would be looking to prove with our field testing.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. An external carbon source composition for use in the biological denitrification of wastewater comprising:
a diluent; and
a surfactant, wherein the diluent concentration ranges from about 50% to about 99% of the composition and the surfactant concentration range from about 1% to about 50% of the composition.

2. The external carbon source composition of claim 1, further comprising additional components at a concentration ranging from about 1% to about 30% of the composition.

3. The external carbon source composition of claim 1, wherein the diluent is crude glycerin and the surfactant is polysorbate 80.

4. The external carbon source composition of claim 3, wherein the diluent concentration is about 90% and the surfactant concentration is about 10%.

5. The external carbon source composition of claim 2, wherein the diluent is crude glycerin, the surfactant is polysorbate 80, and the concentration of additional components is a result of the lack of purity in the crude glycerin.

6. The external carbon source composition of claim 3, wherein the surfactant has been degraded.

7. A method for biological denitrification of wastewater comprising: providing an external carbon source comprising:
a diluent; and
a surfactant, wherein the diluent concentration ranges from about 50% to about 99% of the composition and the surfactant concentration range from about 1% to about 50% of the composition.

8. The method for biological denitrification of wastewater of claim 7, further comprising additional components at a concentration ranging from about 1% to about 30% of the composition.

9. The method for biological denitrification of wastewater of claim 7, wherein the diluent is crude glycerin and the surfactant is polysorbate 80.

10. The method for biological denitrification of wastewater of claim 9, wherein the diluent concentration is about 90% and the surfactant concentration is about 10%.

11. The method for biological denitrification of wastewater of claim 8, wherein the diluent is crude glycerin, the surfactant is polysorbate 80, and the concentration of additional components is a result of the lack of purity in the crude glycerin.

12. The method for biological denitrification of wastewater of claim 9, wherein the surfactant has been degraded.

13. The method for biological denitrification of wastewater of claim 7, wherein the external carbon source is added after phosphate removal is completed.
